(19) United States
(12) Patent Application Publication
(10) Pub. No.: US 2020/0149946 A1
(43) Pub. Date: May 14, 2020

(54) Orbit Baby Bottle Measurement

(71) Applicant: Natalie Anne Woodbury Gray, Delaware, OH (US)

(72) Inventor: Natalie Anne Woodbury Gray, Delaware, OH (US)

(21) Appl. No.: 16/671,320

(22) Filed: Nov. 1, 2019

Related U.S. Application Data
(60) Provisional application No. 62/758,799, filed on Nov. 12, 2018.

(51) Int. Cl. G01F 23/02; A61J 9/00; A61J 11/00

(52) U.S. Cl. CPC G01F 23/02; A61J 11/00; A61J 9/00

(57) ABSTRACT

The Orbit Baby Bottle Measurement comprises a diagonal measurement of the liquid within a feeding apparatus while said apparatus is in an angled position. Upon the feeding apparatus being diagonal, angled, or otherwise tilted, the volume measurement markings on the bottle align with the liquid therein, to provide accurate measurement of the remaining contents without the bottle needing to be in the upright position.

### CROSS-REFERENCE TO RELATED APPLICATIONS

62/758,799

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### Field of the Invention

This invention relates generally to feeding apparatuses for young children such as babies and toddlers and, more particularly, to the measurement of liquid within the feeding apparatus while it is in use, (diagonal, angled, or otherwise tilted) without having the turn the apparatus nipple up to determine the volume of the contents.

### Description of the Related Art

Feeding apparatuses, such as baby bottles, are frequently used by parents and other caregivers to feed babies and toddlers. There are different varieties of bottles generally known in the art. Such bottles are labeled vertically, to indicate the volume of the contents. The bottle must be vertical, nipple up, to accurately determine the measurement of any liquid therein.

Young children such as infants may only consume specific increments of liquid before needing to be burped, or otherwise relieved of gas bubbles, to prevent their spitting up or regurgitating of the consumed liquid. To ensure a young child has not consumed too much liquid at one time, without having been appropriately relieved of gas bubbles, one must remove the baby bottle from the young child's mouth, turn the bottle upright or nipple up, to measure the remaining liquid within. In doing so, the young child can become agitated and visibly upset that the feeding apparatus has been removed.

A need therefore exists for viewing the remaining volume of liquid within a feeding apparatus, without removing said apparatus from the young child's mouth.

The present invention satisfies these needs.

The features, functions, and advantages may be achieved independently in various embodiments of the disclosure or may be combined in yet other embodiments.

### BRIEF SUMMARY OF THE INVENTION

In accordance with an embodiment of the present invention, the orbit baby bottle measurement is disclosed. Upon the baby bottle being diagonal, angled, or otherwise tilted, the volume measurement markings on the bottle align with the liquid therein, to provide accurate measurement of the remaining contents without the bottle needing to be in the upright position. While, it is recognized that vertical measurement on a feeding apparatus is necessary and useful, this invention adds the tilted measurement feature, for convenience of the parent or caregiver.

### BRIEF DESCRIPTION OF THE SEVERAL VIEWS OF THE DRAWINGS

FIG. 1 demonstrates the side view of a baby bottle with the diagonal orbit measurements, numerically identified to be viewed at an angle. As the liquid in the bottle depletes, the orbit design would allow the parent or caregiver to view, in real-time and without removing the bottle from the child's mouth, the amount remaining within the apparatus.

FIG. 2 illustrates the side view of a baby bottle with the diagonal orbit measurements, numerically identified to be viewed at an angle. As the liquid in the bottle depletes, the orbit design would allow the parent or caregiver to view, in real-time and without removing the bottle from the child's mouth, the amount remaining within the apparatus.

FIG. 3 shows the back view of the baby bottle, with vertical measurement labels.

### DETAILED DESCRIPTION OF THE INVENTION

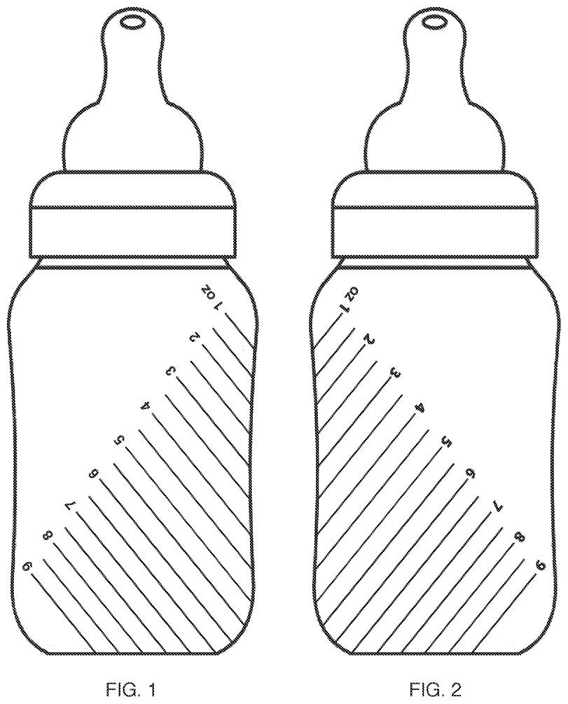

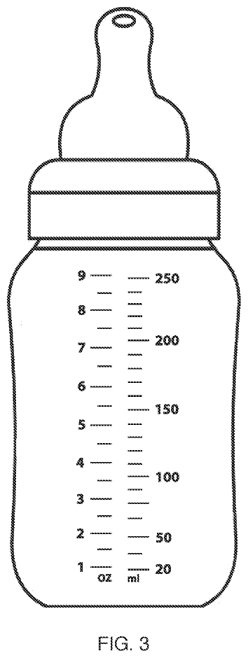

As demonstrated in FIGS. 1 through 3, the volume measurement on the feeding apparatus is diagonal, angled, or otherwise tilted to show the remaining liquid within the apparatus while the apparatus itself is diagonal, angled, or otherwise tilted.

It is the intention to encompass any and all forms of liquid measurement and/or measurement of volume, alone or in any combination thereof, displayed in a diagonal, angled, or otherwise tilted fashion, so as to take, determine, or observe liquid measurement while the apparatus is diagonal, angled, or otherwise tilted.

While the present invention has been described in terms of particular embodiments and applications, in both summarized and detailed forms, it is not intended that these descriptions in any way limit its scope to any such embodiments and applications, and it will be understood that many substitutions, changes, and variations in the described embodiments, applications and details of the method and system illustrated herein and of their operation can be made by those skilled in the art without departing from the spirit of this invention.

1. A container comprised of any material, that is used to hold or administer various contents, wherein the improvement comprises direct visual confirmation of the remaining contents within the container while the container itself is diagonal, angled, or otherwise tilted.

2. A container according to claim 1, further comprised of glass, plastic, metal, or a combination thereof, that is used to hold or administer various contents, wherein the improvement comprises direct visual confirmation of the remaining contents within the container while the container itself is diagonal, angled, or otherwise tilted.

3. A container comprised of any material, that is used to hold or administer liquid, wherein the improvement comprises direct visual confirmation of the remaining liquid within the container while the container itself is diagonal, angled, or otherwise tilted.

4. A container according to claim 3, further comprised of glass, plastic, metal, or a combination thereof, that is used to hold or administer liquid, wherein the improvement comprises direct visual confirmation of the remaining liquid within the container while the container itself is diagonal, angled, or otherwise tilted.

5. A drinking apparatus comprised of any material, that is used to hold or administer liquid, wherein the improvement comprises direct visual confirmation of the remaining liquid within the container while the container itself is diagonal, angled, or otherwise tilted.

6. A drinking apparatus according to claim 5, further comprised of glass, plastic, metal, or a combination thereof, that is used to hold or administer liquid, wherein the improvement comprises direct visual confirmation of the remaining liquid within the container while the container itself is diagonal, angled, or otherwise tilted.

7. A feeding apparatus comprised of any material, characterized by an artificial nipple, wherein the improvement comprises direct visual confirmation of the remaining liquid within the container while the container itself is diagonal, angled, or otherwise tilted.

8. A feeding apparatus according to claim 7, further comprised of glass, plastic, metal, or a combination thereof, characterized by an artificial nipple, wherein the improvement comprises direct visual confirmation of the remaining liquid within the container while the container itself is diagonal, angled, or otherwise tilted.
